(19) United States
(12) Patent Application Publication
(10) Pub. No.: US 2005/0234881 A1
(43) Pub. Date: Oct. 20, 2005

(54) Search wizard

(76) Inventors: Anna Burago, Kirkland, WA (US); Alexandra Vaschillo, Redmond, WA (US)

Correspondence Address: ALEXANDRA VASCHILLO, 10724 183 AVENUE NE, REDMOND, WA, 98052, US

(21) Appl. No.: 10/826,206

(22) Filed: Apr. 16, 2004

(51) Int. Cl. G06F 17/30

(52) U.S. Cl. 707/3

(57) ABSTRACT

A method of generating suggestions for search criteria that improve searching in a database of documents, by analyzing the documents comprising the result of the first search to find at least one potential search criterion met by at least one of the documents; and choosing search criteria that are met by a number of documents between two thresholds and give substantially different search results. An interactive and iterative method of searching a database of documents where each iteration uses criteria obtained from the analysis of the results of previous iteration.

### BACKGROUND OF THE INVENTION

1. The Field of the Invention

The present invention relates generally to the field of retrieval of data and, more particularly, to interactive searching of textual information and, specifically, to keyword based searching in document databases.

2. Background of the Invention

With the abundance of information available to the public nowadays, the challenge of finding the information relevant to the topic desired has become a very important issue. One of the examples of a huge database with enormous amount of information and no clear way to extract relevant information is Internet and World Wide Web. A number of search engines have been implemented that people use daily to find the information they are looking for. However, since the information is unstructured and the interface to the search engine is most commonly a number of keywords possibly with Boolean expressions, formulating a proper query that is capable of returning appropriate results is too challenging to most people using the internet today.

In most cases the interaction of people with a search engine is a tiresome interactive process involving:
1. specifying the initial query,
2. executing this query against a search engine,
3. reading through several of the returned results,
4. understanding the reasons the initial query could not produce satisfactory results,
5. inventing ways to restate the query to increase the likelihood of obtaining satisfactory results,
6. refining the query by adding or removing keywords,
7. repeating steps 2 to 7 until the result is satisfactory (required information is found).

The most common problems people encounter are:
Inability to formulate a concise query. People often type a single word in the search engine input string such as “mints” hoping to find a scientist with surname “Mints”, but get back thousands of results some of which talk about candy, some about growing mint plants, some about coin mints, some about recipes that include peppermint.
Inability to sort through huge amount of results returned.
Inability to come up with proper keywords that will refine their query.
Inability to specify the areas (like “Coin printing”) that they want to exclude from the search using the language of keywords to precisely cut off the area they intend to cut off.
Lack of statistical data allowing evaluating how efficient including or excluding a keyword from a search query is going to be for refining the search.

The problems described above become even harder in the multinational environment which is common for such databases as Internet. For example when a person whose native language is other than English tries to formulate a query to find some information in English language, it is often too hard for her to find and formulate the right keywords, find synonyms, describe the problem domain in the right terminology.

As a result, people spend hours and hours trying to find information they are looking for and often become frustrated before they can get to acceptable results. A number of “professional search” services are now available where trained professional searchers will search the Web to find the information for their clients for a fee.

Automating search efforts, automatically providing suggestions for improving the search is one of the aspects of the present invention.

A lot of work is being done nowadays in this area, with the focus being on assisting users in their search efforts. Some search engines provide hierarchical structuring of all (or some of the) available information to try to classify said information into categories that are easier to search and navigate. One of examples of such implementations is “Yahoo Categories”. There are many disadvantages in this approach. Some of these disadvantages are listed below:
The categories are usually created manually by some experts. However, the way these experts divide the search space into categories is not standardized and is often misunderstood by people. People often do not know whether to search for “Cat food” under the category for “animals”, “food”, or “pet supplies”.

Categorization of Web documents is a huge task since the documents change frequently and uncontrollably. As a result this categorization is usually available only for a small subset of the available information and even that requires constant support activities.

A lot of the time cross-category searches are needed by the users. Categories are rigid structures and are very unfriendly to this type of searches.

As a result, only a very limited number of WWW users choose to make use of the Categories in their search for information.

One of the aspects of the present invention overcomes most of these issues by making categorization dynamic, created on the fly with understanding of the needs of a particular user, adding fuzziness into this categorization and allowing practically unlimited sub-categorization.

A lot of work is being done in the area of automatic clustering of the web sites based on similarities and/or categorizations. However, these efforts lack some important functionality such as:
Iterative approach to search and clustering—they do the clustering at most once per search session and do not provide for re-clustering based on search refinement http://www.mooter.com
Interactive approach—they try to rely on their own predefined static knowledge and algorithmic processing of said knowledge about the search space instead of soliciting more input from the user or adjusting to the specifics of the results retrieved from the database.
Flexibility of clustering—some use predefined set of categories to cluster into, and often pre-computed criteria of clustering.
Clustering of the search criteria—they are clustering the wrong thing: they attempt to cluster the web sites instead of clustering the search criteria.
   Overview of the Prior Art:

While many people worked in this area and produced significant results, none of the prior inventors accomplished the following aspects that our invention accomplishes:
Provide a method for analyzing current search results with the goal of coming up with effective suggestions as to what additional search criteria can be added to or excluded from the further search based on this analysis, where the suggestions are optimized to provide desirable effect of the future search iterations.

Apply this method iteratively in a dialog with the user, refining the search through as many iterations as needed to achieve the desired result
None of the prior inventions is able to intelligently suggest negative search criteria that should be excluded from the search space

In particular, [U.S. Pat. No. 6,675,159 by Lin et al., 20030101182 by Govrin et al., 20040044952 by Jiang et al.] use lexical analysis and natural language processing of documents in the search domain to enhance the performance of a search engine. This kind of technique however is limited to being used on the execution step, only after a search query has been already formulated, it does not ask for additional input from its user and does not help user to formulate the query.

The inventors in [U.S. Pat. No. 6,701,310 by Sigura et al.] use analysis of the search results to redirect the query to a topic-centered search engine specializing on a particular topic as inferred from the said results. Again, they do not help formulating the query.

Similarly, [U.S. Pat. No. 6,510,406 by Marchisio, 20040059729 by Krupin at al., 20030225751 by Kim] analyze the user's query and try to come up with an equivalent query that would perform better by, for example, including synonyms for words used in that query. These techniques do not involve any analysis of the search result and can only provide a limited number of alternatives to the original query.

Inventors in [20040049503 by Modha et al., 20020042789 and 20020065857 by Michalewicz] use natural-language processing and statistical algorithms to analyze the results of a search performed by the user in order to cluster the documents in this result and to present it to the users in a more comprehendible way. These approaches do not involve any iterations of the search process and do not generate any suggestions as to what the search criteria of such iterations could be. After the document clusters are presented to the users, the users are left to their own means should they find the said results unsatisfactory. One of the known implementations of a similar technique can be found here: http://www.mooter.com.

Finally, many inventions [20030217052 by Rubenczyk et al., U.S. Pat. No. 6,578,022 by Foulger, et al., U.S. Pat. No. 6,647,383 by August et al., U.S. Pat. No. 6,223,145 by Hearst] rely on additional structures, such as pre-set categories and hierarchies, or processed logs of previous searches by the same or different users, to help the users achieve their objectives. These inventions work in a controlled environment where the set of documents can be controlled and new categories or new search criteria can be input manually or by a software agent upon addition of a new document to the search domain. Such maintenance however is often very costly. Furthermore, this type of approach could never work in such uncontrolled environment as Word Wide Web, where documents, as well as new terms and concepts, are added and deleted every second all over the world.

In brief, some approaches try to refine the search result based on pre-defined data such as manually input categories and hierarchies, and others analyze the search results for clustering the documents within, and better presentation of the result. One of the aspects of the present invention unavailable in any of the related inventions is the analysis of the search results of the previous iteration to efficiently come up with optimized search criteria for the next iteration.

### SUMMARY OF THE INVENTION

The following summary provides an overview of various aspects of the invention described in the context of the related inventions incorporated-by-reference earlier herein (the “related inventions”). This summary is not intended to provide an exhaustive description of all of the important aspects of the invention, nor to define the scope of the invention. Rather, this summary is intended to serve as an introduction to the detailed description and figures that follow.

The object of this invention is to provide a search system that guides a user in their search efforts by providing them with search suggestions that allow for efficient iterations that bring them to the desired result.

We invented a new way to assist users in searching for information that includes the following:
Obtaining the first search criteria from a user.
Executing a search with said first criteria.
Obtaining at least one of the search results.
Analyzing said results by:
   Identifying at least one potential additional search criteria;
   Grouping said search criteria based of the similarities of the way they affect the search results;
   Identifying at least one of the said groups that has desirable search criteria;
   Identifying at least one best representative criteria from at least one group.
Presenting said chosen representative criteria for said chosen groups to the user.
Obtaining opinion of the users on which criteria describe their:
   desired results;
   undesired results.
Using said opinion to formulate new search with updated criteria by:
   Updating the list of positive criteria with the help of the said desired results;
   Updating the list of negative criteria with the help of the said undesired results;
Iteratively repeating the said algorithm until user is satisfied with the result.

We also invented a new way of coming up with suggestions for the user for improving the search criteria so that they produce better search results. It includes the following:

Analyzing the results of initial search (set of documents) to identify the words or phrases that can serve as candidate suggestions by:
Preferably stripping said documents of hypertext markup;
Preferably stripping said documents of scripts and other bodies not directly relevant to the semantics of content;
Preferably stripping said documents of auxiliary words, such as articles, auxiliary verbs, prepositions, pronouns and the like;
Preferably normalizing word forms;
Identifying pairs of words, and/or longer combinations of consecutive words that are contained within said documents.

Grouping said candidate suggestions by the way they affect the future search results if included in the search query. Those that produce similar search results are grouped together.
In one preferred embodiment of this invention, the candidates are ranked by the number of different result documents that they are contained within, and those that rank too low or too high are excluded.
In one preferred embodiment of this invention, the candidates are grouped by the following algorithm:
   For each candidate, the bit vector of its occurrences within said documents, one bit per document, is calculated;
   Those candidates that have strong correlations of said bit vectors are grouped together.

In each group we identify representatives. Although all candidates potentially produce similar results if used in the future search iterations, we select those that produce better results among others in the group.
In one preferred embodiment of this invention, those candidates that correlate with other candidates in this group better are given a bonus.
In one preferred embodiment of this invention, those candidates that correlate with other candidates outside this group are given a penalty.
In one preferred embodiment of this invention, those candidates that consist of generally less frequent words are given a bonus.
In one preferred embodiment of this invention, if there is a single word that correlates well with the candidates within this group, it is added to the candidates in this group, and given a bonus.
In one preferred embodiment of this invention, those candidates that occur in the greater number of documents are given a bonus.
Those candidates that have the largest bonus are considered selected candidates.

The selected candidates are presented to the users for their decision on which of these selected candidates should be added to the search query as phrases to include into the next search iteration, added to the search query as phrases to exclude from the next search iteration, or ignored.

We also invented a user interface that improves search productivity of users and includes the following:

A panel presenting search results of the current iteration.

A panel representing search criteria suggested to the user.
For each of the selected suggested criteria, a set of buttons or other means that allow users to indicate that a particular search criterion:
   is desirable in the search query;
   is undesirable in the search query; or
   indicate that they do not have a preference for this criterion.

The search criteria of the current search iteration.

A button or other means for the user to indicate that she has finished selecting the criteria and wishes to proceed to the next iteration.

Preferably, buttons that allow the user to navigate back and forward along the sequence of already executed iterations.

Our method and system is superior to prior inventions because:
By prompting users with search criteria suggestions, it guides the users and allows them to iteratively improve the quality of the results of their search. Users can go through as many iterations as required to achieve a satisfactory result.
It can generate suggestions without any pre-processing of the search domain, without any manual categorization or hierarchy imposed on the search domain.
It is dynamic and is not limited to a fixed set of pre-programmed search suggestions. The suggested new search criteria are obtained from the analysis of the result of the current iteration and are context-dependent.
It suggests search criteria that improve the result of the next iteration of the search process both in case when they are marked by the user to be included or excluded from the search.
It suggests search criteria that are more intelligible by end-users.
It is tolerant to users ignoring some of the suggestions that did not make sense to them.

### BRIEF DESCRIPTION OF THE DRAWINGS

The foregoing summary, as well as the following detailed description of the invention, is better understood when read in conjunction with the appended drawings. For the purpose of illustrating the invention, the drawings show exemplary embodiments of various aspects of the invention; however, the invention is not limited to the specific methods and instrumentalities disclosed. In the drawings:

FIG. 1 is a block diagram representing a computer system in which aspects of the present invention may be incorporated, and the data flow between the blocks in such computer system;

FIG. 2 is a block schema of one of the embodiments of the algorithm representing major steps in this algorithm;

FIG. 3 is a block schema of a user's interactions with the system;

FIG. 4 is a screenshot of one of the embodiments of the invention with the results of the execution of the following query: “cannas”;

FIG. 5 is a screenshot of one of the embodiments of the invention with the results of the execution of the following query: “cannas gardening”;

FIG. 6 is a screenshot of one of the embodiments of the invention with the results of the execution of the following query: “cannas ‘Plant Cannas’”;

### DETAILED DESCRIPTION OF THE PREFERRED EMBODIMENTS

The present invention has a number of enhancements above and beyond the existing search algorithms and interfaces. It allows users to find information that is almost impossible to find with the existing search tools.

In the preferred embodiment described in this chapter we use a commercial search engine such as Yahoo or Google via HTTP interface these services expose. The invention however is not limited to any of these and can be used for example to search any relational databases, USPTO database, retailer databases, etc.

When searching the Web using a search engine like Google, users often have problems formulating the query for their search. Usually they type in a keyword or a sequence of keywords that they think describe the thing they are searching for. More often than not, the search engine has a different understanding of the query and returns results that are different from what user expected. Users must then refine their query by adding, removing or changing some of their keywords and restarting the search.

The task of coming up with the keywords that accurately and precisely describe the thing user is looking for is however a very difficult one. It is a common case for the user to see thousands of results returned to her, where each of the results matches the query, but not in the way that the user intended. Furthermore, it is very hard for the user to formulate the difference—the exact set of keywords that will separate the results she is looking for from the results she does not want to see.

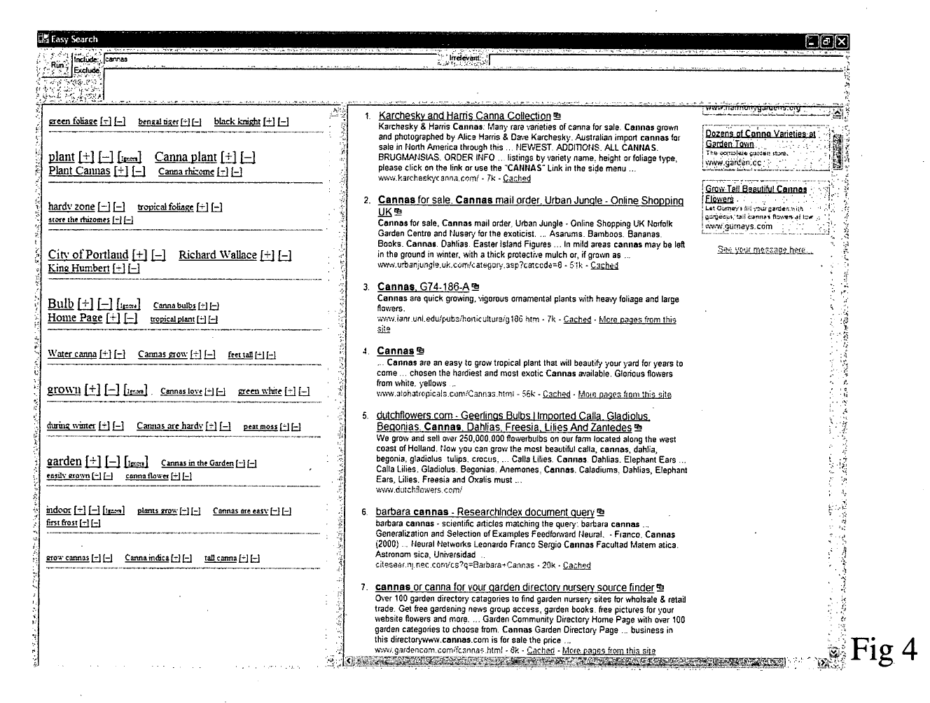

For example a user wants to find general information about cannas. What she means is that she wants to find out how to plant cannas in her garden, and how to care for them. A typical user will just type “cannas” into the search engine and hope for the best. However, as we can see in FIG. 4, a search engine returns thousands of links that are not really relevant to the concept user meant. Most of the web sites found are the web sites of internet retailers selling cannas, some describe cannas collections and different varieties, yet some describe scientific works of people whose last name is “Cannas”, such as a web site of Barbara Cannas in FIG. 4. All of these results are relevant to the query user asked, but not relevant to the information she was searching for.

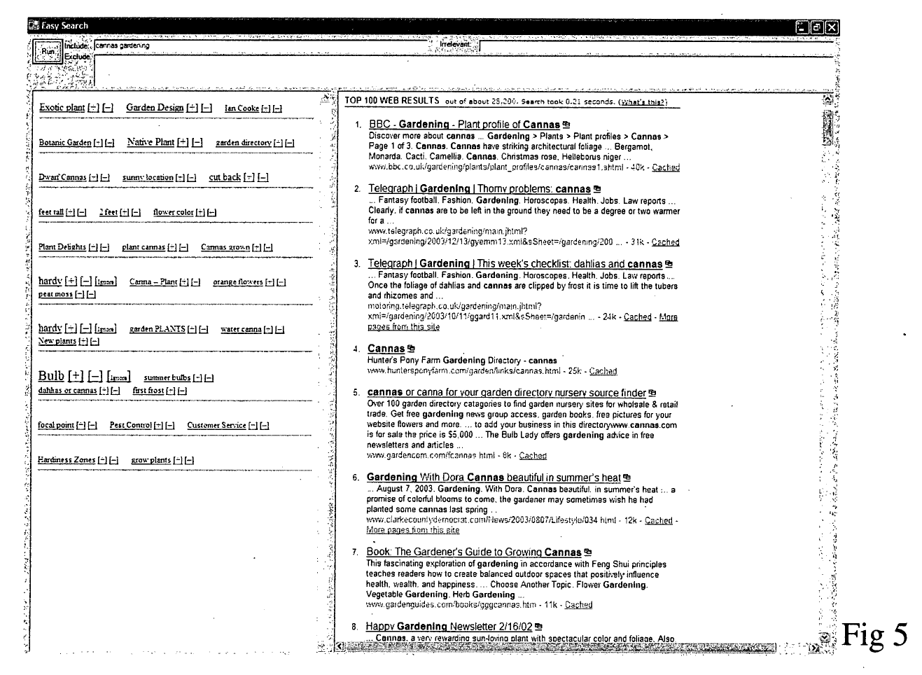

This means that the query user asked is imprecise, allows misinterpretations, and/or covers too much of the search area. The user feels she needs to reformulate the query to try to be more specific and/or to try to cut off the areas that are not of interest to her. However, this proves to be a task that most users can not cope with. The users we observed tried to change the query to “cannas gardening”, which did not help to improve their search results much. As shown in FIG. 5, none of the links returned by the search engine answer the user's needs. Even the promising link entitled: “Book: The gardeners guide to growing cannas”, figures out to be just an internet retailer selling this book.

At this point the user usually makes a couple of other attempts and becomes frustrated at the computer being unable to understand her query the way she formulated it.

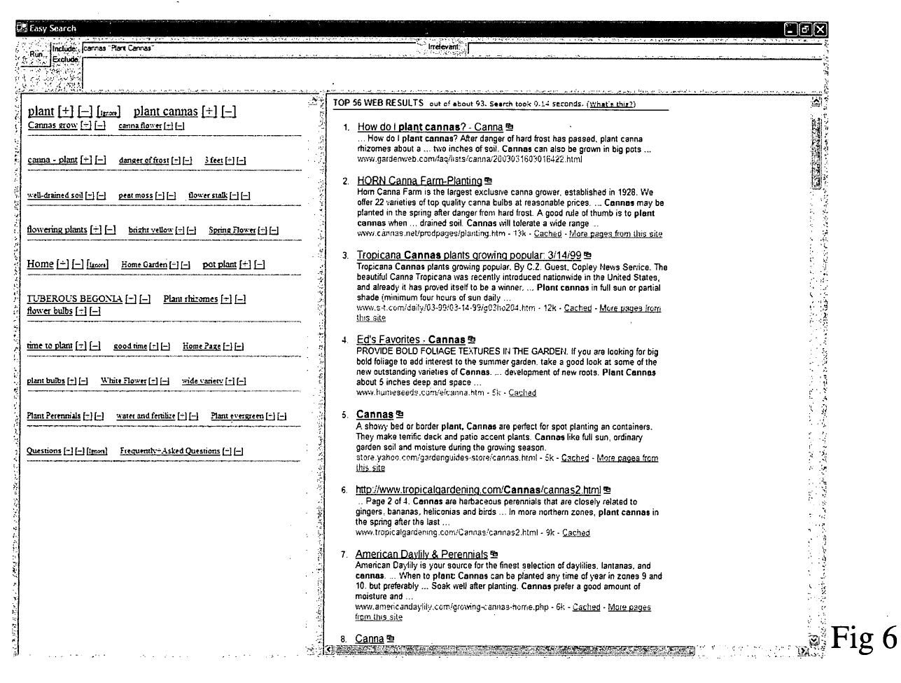

One of the aspects of the present invention is to generate useful suggestions for the user to be able to reformulate her query. If you look at the left pane in FIG. 4, you will see a list of suggestions generated by our tool (which is a preferred embodiment implementing some aspects of the present invention). These suggestions are carefully selected by our algorithms to efficiently reduce the search space and help the user to locate her desired information. Looking at FIG. 4 one would almost immediately notice a suggestion “plant cannas” in big letters close to the top of the pane, choose it and get a list of results (FIG. 6) all of which are relevant, give tips on planting cannas and are exactly what our user is looking for.

The trick here was to choose the keyword “planting cannas” that not only helps user formulate her thoughts more precisely, but also formulates it in the way that the search space (World Wide Web in this example) treats as being precise, efficient and helpful. This allows user to reformulate the query in terms that the database will “understand” better instead of the terms that seem to better describe the concept to the user. The present invention includes a method of providing user with suggestions on how to reformulate her query.

Another powerful tool that is sometimes present in the search engine is the ability to mark some words as being excluded form the search. For example in the “cannas” example we have looked at, the user might want to indicate that the web sites that sell cannas are not interesting to her. Most web search engines provide this functionality by allowing user to specify a keyword with a minus sign as in “−sell”, or have some other interface to provide for a similar functionality. We will call this feature “minus” feature, and the keywords to exclude “minus keywords”.

While being a powerful feature, “minus” is rarely used by users, mostly because it is very hard to specify the right “minus” keyword. In our example if the user tries to specify “−sell”, this is not going to help her much. The present invention is very useful to clearly identify those keywords that will work well if used as “minus” keywords, thus giving users a way to efficiently use the “minus’ feature. The present invention includes a method to use the “minus” feature efficiently.

Method of choosing suggestions based on how well they affect future search iterations.

Our goal is to generate a number of suggestions that will help user refine their search. We are looking for keywords that are characteristic to some part of the search space. If some keyword is characteristic to 50% of the documents, then it makes sense to show it to the user and ask her if she meant to look for this thing, or not. If she chooses to use this keyword (either with “plus” or “minus”), her action will essentially reduce the search space by 50%. While 50% is the ideal number, suggestions that reduce the search space by other percentages are also acceptable. The closer to 50%—the better.

Another important goal is for the keywords to represent a concept user can be searching for as accurately as possible, so that the probability of misunderstanding between the user and the search engine is minimized. For example in the phrase “may be left in the ground” the keyword “may be left” is much less representative than the keyword “left in the ground”.

Below we show an algorithm we used to achieve the above goals.

In order to generate the keywords for suggestions we first run the initial query against a Web Search Engine and retrieve the documents that the search engine returns. In one preferred embodiment we only retrieve the first 100 such documents to optimize the performance of the algorithm by using this representative sample instead of the full result.

We then pre-process these documents by clearing their text of HTML markup, scripts, and other irrelevant parts and analyze the resulting text. We found out that gathering statistics on single words in the documents does not produce desirable results. However, analyzing pairs of words or sequences of two or more words works much better. Thus, in this preferred embodiment our keywords will mostly be pairs of words, with occasional single words or sequences of more than two words.

We statistically analyze the documents and for each keyword calculate the number of documents it was present in. We then rank these keywords by how close this number is to 50% and select those keywords that rank higher. We then group the selected keywords into groups based on their similarity with respect to the documents. We treat two keywords as similar if they occur in roughly the same set of documents. The numerical value of this similarity is given by taking mathematical correlation of the following function for these two keywords. This function is defined for each keyword and takes document as an argument. For each document it returns 1 if the keyword is present in this document and 0 otherwise. The premise is that the keywords within the same group will have roughly the same effect of the results of the search.

Now, for each group we need to find representative keywords that will be shown to the user. Although they have roughly the same effect, several other factors are being weighted in:
Some of the keywords occur in a greater number of documents. Those will be given preference.
The correlation of a keyword to other keywords in the group. The higher the correlation the more preference the word gets.
The correlation of a keyword to other keywords outside the group. The higher the correlation the less preference the word gets.
Linguistic aspects of the keyword, such as the general frequency of the word. In the preferred embodiment we use the frequency dictionary for the English language to measure this. The more frequent is the word—the less preference it gets, because it is less likely to represent a precise and accurate concept.
   User Interface

Another aspect of the present invention is the graphic user interface that allows using our search algorithm in a simple point and click fashion. The tool includes two panes and a number of input fields and buttons. The first pane displays suggestions generated by our algorithm; the second pane displays the results of the search. One input field displays the list of keywords to be included, the other one displays the list of keywords to be excluded. The “Run” button initializes search iteration based on the criteria in the input fields.

Once user inputs the initial search criteria into the input field and clicks on the “Run” button, a search is executed against the search engine and the results are displayed in the second pane. At the same time our algorithm starts processing the results and once ready displays generated suggestions in the first pane.

The suggestions in the first pane may have a plus or minus sign next to them. Clicking on the plus sign next to the suggested keyword adds this keyword to the list of included (“plus”) keywords, and clicking on the minus sign next to the suggested keyword adds this keyword to the list of excluded (“minus”) keywords. Clicking on the keyword itself temporarily displays the effect of using this keyword as a “plus” keyword in the second pane.

User can quickly look through all or some of the suggestions and make her choices on one or several of them. Then she clicks on the “run” button and the next search iteration is executed. This GUI also allows user to get an idea about the results of the search without reading the documents, which reduces the time user spends searching.

In one of the preferred embodiments we show the keywords that will cause greater effect on the search results using a larger font. The size of the font is directly proportional to the usefulness of the keyword (either as a “plus” keyword or as a “minus” keyword).

In one of the preferred embodiments we mark the group of keywords where at least one keyword has already been chosen by the user in a different color. This allows user to clearly see which groups are already accounted for and avoid clicking on several keywords in the same group, which is likely to have little additional effect on the results of the search.

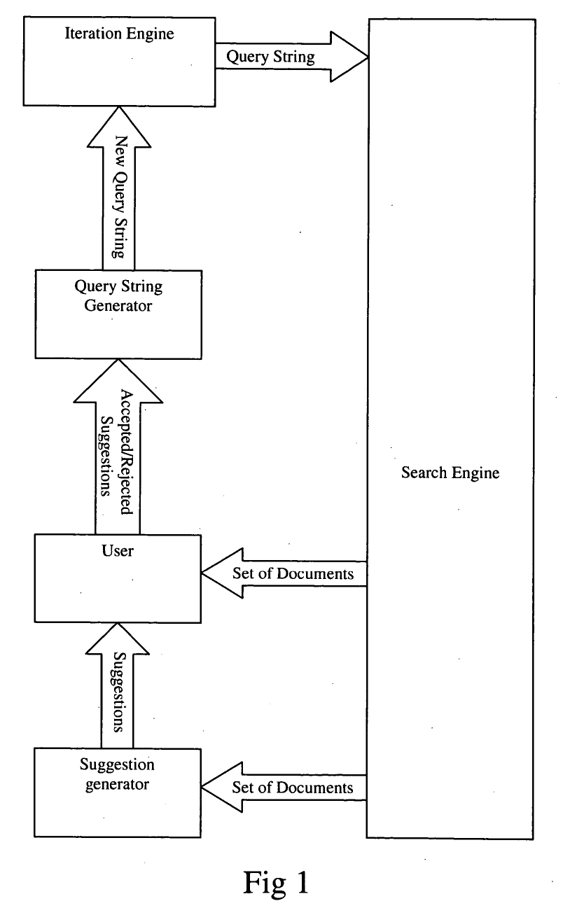

FIG. 1 shows the general guidelines for the modules in the computer system implementing the preferred embodiment. An “Iteration Engine” sends a “Query String” to a “Search Engine” (which can be a World Wide Web search engine like Google or Yahoo, or any other search engine). A “Set of Documents” is returned to the “User” for viewing, and the same “Set of Documents” is returned to the “Suggestion Generator” for generating suggestions. The “Suggestion Generator” sends the “Suggestions” it generated to the “User” and the user views both the “Set of Documents” and “Suggestions” to see if she is satisfied with the search and to mark some of the “Suggestions” as accepted or rejected. The “Accepted/Rejected Suggestions” are then sent to the “Query String Generator” which in turn transforms these suggestions into a “New Query String”. The “New Query String” is used by the “Iteration Engine” to reiterate the query against the “Search Engine”.

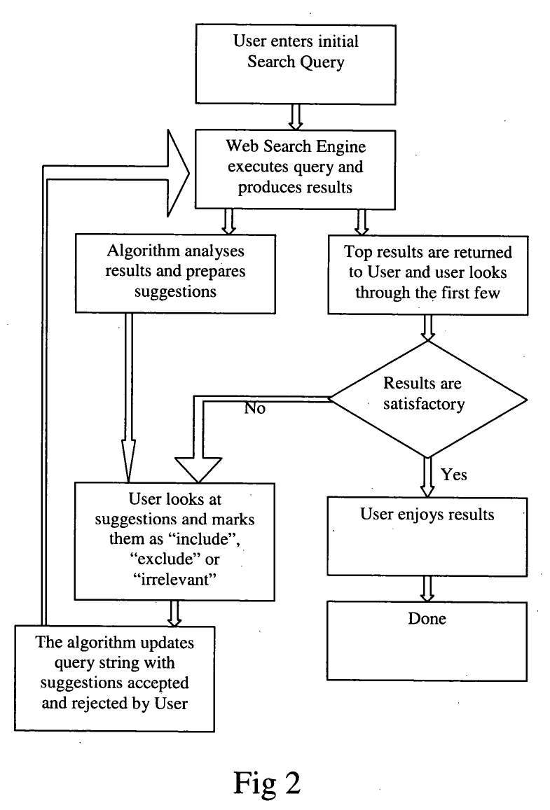

FIG. 2 shows the outline of the algorithm that may be used in the preferred embodiment. The search process starts when user enters the initial search query into the Search Wizard tool. The Web search engine executes the query and produces results in the form of a set of documents that meet the query requirements. At this point two branches are executed in parallel. In the first branch a subset of the results (top several documents) are returned to the user. The user views them and if the results are satisfactory the process is over—user views the documents she was looking for. If the results are not satisfactory (the set of the documents returned does not contain the information user was looking for), or if the user does not wish to spend time reading the initial results, but rather prefers to refine the search based on the suggestions, then the user looks are the results of the execution of the second branch. The second branch takes the set of the documents returned and prepares suggestions to the user. The user then views said suggestions and marks them as “include”, “exclude” or “irrelevant”. The algorithm then updates the query string based on user's input and reiterates the search. The algorithm may be executed multiple times until the user is satisfied with the results.

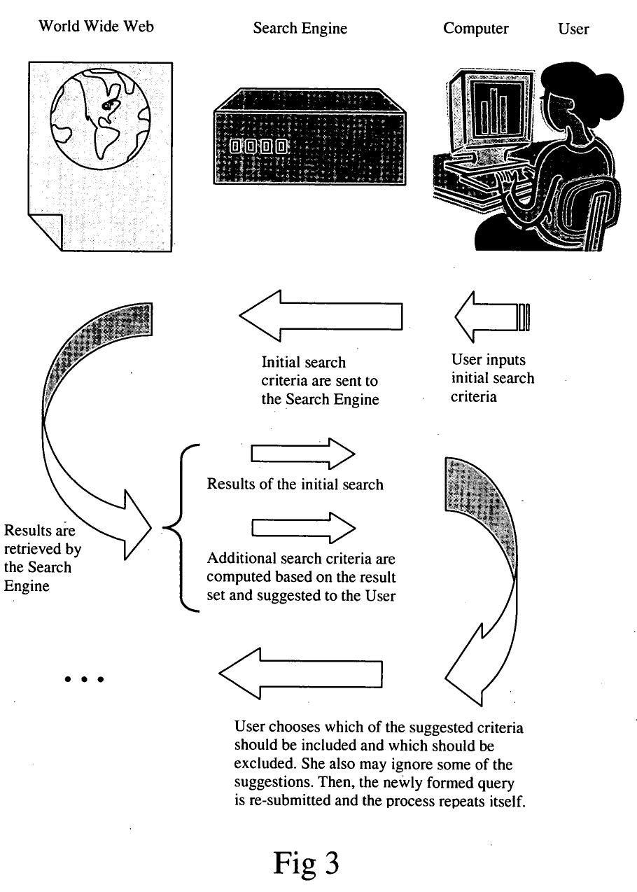

FIG. 3 shows the user's interaction view on the system. The World Wide Web contains a huge number of documents. Some of those documents contain the information user is looking for. The search engine is a computer program that takes user's input query and uses it to filter World Wide Web documents to return only those documents that match the user's query. Formulating the query however, is a hard task for the user and users do not usually manage to formulate a query that will return the information they wanted. Once the initial search is completed based on the initial search criteria given by the user, a set of new search criteria is shown to the user from which she can choose the ones she wants to include, exclude or ignore. The newly formed query based on the new set of criteria is resubmitted to the search engine and the process iterates until the user is satisfied with the results.

1. A method of generating at least one suggested search criterion that improves searching in a database of documents, said method comprising of:
analyzing the documents comprising the result of the first search to find at least one potential search criterion met by at least one of said documents;
choosing at least one search criterion among said potential search criteria that is met by a number of said documents, where said number is greater than a certain lower threshold and less than a certain upper threshold;
choosing a subset of said chosen potential search criteria such that a criterion outside the subset is met by a set of documents close to the set of documents met by at least one of the search criteria in the said subset.

2. The method of claim 1, wherein said thresholds are set at some fixed percentages of the number of documents in the said first search result.

3. The method of claim 1, wherein said thresholds are adjusted based on the analysis of the said first search result.

4. The method of claim 1, wherein said database of documents is World Wide Web, or a subset thereof.

5. The method of claim 1, wherein types of said documents include but are not limited to hypertext documents, Web pages, text documents.

6. The method of claim 1, wherein said result of first search is a set all documents meeting the search criteria of said first search.

7. The method of claim 1, wherein said result of first search is a subset of all documents meeting the search criteria of said first search.

8. The method of claim 1, where said choosing a subset is achieved by grouping said chosen search criteria into at least one group where said criteria within each said group are similar with respect to searching.

9. The method of claim 8, wherein said similarity is calculated as correlation of two functions that describe the appearance of said criteria in said documents.

10. The method of claim 8, further comprising selecting at least one search criterion within at least one group and assigning said selected search criterion as representative of this group.

11. The method of claim 10, wherein said selection is based in part on correlation of potential representative to other criteria within said group.

12. The method of claim 10, wherein said selection is based in part on correlation of potential representative to criteria outside said group.

13. The method of claim 10, wherein said selection is based in part on pattern of occurrences of said potential representative in said documents.

14. The method of claim 10, wherein said selection is based in part on ability of said potential representative to divide the search space.

15. The method of claim 10, wherein said selection is based in part on linguistic information.

16. The method of claim 10, wherein said selection is based in part on contextual information.

17. The method of claim 1, wherein said potential criteria comprise a phrase and a procedure of matching said phrase to phrases contained in said documents.

18. The method of claim 17, wherein said phrases comprise sequences of two or more words.

19. The method of claim 17, wherein said procedure comprising matching each word in said phrase to a sequence of words in said documents.

20. The method of claim 19, wherein said procedure includes disregarding:
auxiliary words;
hypertext markup;
scripts; and
other information not directly related to the semantics of the document.

21. The method of claim 19, wherein said matching includes linguistically normalizing word forms.

22. An interactive method of searching a database of documents comprising the following steps:
accepting the first search request from user;
executing the said search request;
analyzing the result of said search request execution;
calculating at least one new search criterion based on said analysis;
allowing the user to select at least one said new criteria; and
iterating said algorithm to refine the search results, wherein each subsequent iteration involves new analysis of results obtained in the previous iteration.

23. The method of claim 22, wherein said database of documents is World Wide Web, or a subset thereof.

24. The method of claim 22, wherein types of said documents include but are not limited to hypertext documents, Web pages, text documents.

25. The method of claim 22, wherein user can choose at least one of the said selected new criteria to be added to said search request for subsequent iterations.

26. The method of claim 22, wherein user can choose a complement of at least one of the said selected new criteria to be added to said search request for subsequent iterations, where complement of a criterion is defined as a new criterion that is met by a document if and only if the said document does not meet the original criterion.

27. The method of claim 22, wherein at least one of search criteria in the said search request can be ignored.

28. The method of claim 22, wherein at least one search engine is used to execute the said search request.

29. A computer program product for use in a computer system, the computer program product for assisting the user in searching, the computer program product comprising one or more computer-readable media having stored thereon computer executable instructions that, when executed by a processor, cause the computer system to perform the following:
accept the first search request from user;
execute the said search request;
present the user with the result of said search request execution;
analyze the result of said search request execution;
present user with suggested search criteria that are selected based on said analysis to optimize the next search iteration;
allow user to select at least one said new criteria and add it to the search request;
allow user to select at least one said new criteria and add its complement to the search request; and
allow user to iterate the algorithm outlined here to refine the search results.
